(19) United States
(12) Patent Application Publication
(10) Pub. No.: US 2025/0327147 A1
(43) Pub. Date: Oct. 23, 2025

(54) BATTERY BREAKER COMPRISING AUTOMATED FEEDING SYSTEM

(71) Applicant: ACE GREEN RECYCLING INC., Houston, TX (US)

(72) Inventors: Avijit Gautam, Noida (IN); Mayankkumar Mohanbhai Patel, Salaiya (IN)

(73) Assignee: ACE GREEN RECYCLING INC., Houston, TX (US)

(21) Appl. No.: 18/638,683

(22) Filed: Apr. 18, 2024

(51) Int. Cl. C22B 1/248; B02C 23/02; H01M 10/54

(52) U.S. Cl. CPC C22B 1/248; B02C 23/02; H01M 10/54

(57) ABSTRACT

Disclosed are solutions for automatically feeding macro-batches of lithium-ion batteries (LIBs) as feedstock into a battery breaker at controlled intervals and/or with a controlled flow rate to achieve more efficient and less-problematic breaking. This automatic feeding is achieved through the utilization of a specially-designed feeding system that overcomes the challenges that heretofore have necessitated manual feeding for LIB breaking, said feeding system featuring an automated hopper system, a cooling system, or both. The hopper system may be further augmented with a vibration-inducing motor, and/or the hopper system may further comprise channels through which coolant from the cooling system may pass.

### BACKGROUND

Reclaiming the various components from spent lithium-ion batteries (LIBs) begins with “breaking” the batteries and grinding down to a fine powder for recovery of component materials. Although various spent LIBs may be segregated into different batches for breaking, such segregation is time and resource intensive and therefore uncommon. Instead, spent LIBs of various sizes and compositions are typically mixed together and separated into batches based only the most general distinctions (which may be referred to herein as “macro-batching”).

Current industry practice is to feed such batches into the breaker manually because LIB feedstock may comprise LIBs that are only partially discharged, mostly charged, or even fully charged and, when these cells are broken in the battery breaker, the metallic lithium may become exposed to atmospheric moisture and chemical reactions can occur that generate damaging heat. However, manual breaker feeding is slow, inefficient, and resource-intensive.

### SUMMARY

Disclosed herein are various implementations directed to automatically feeding macro-batches of LIBs as feedstock into the breaker at controlled intervals and/or with a controlled flow rate to achieve more efficient and less-problematic breaking. This automatic feeding is achieved through the utilization of a specially-designed feeding system that overcomes the challenges that heretofore have necessitated manual feeding for LIB breaking, said feeding system featuring an automated hopper system, a cooling system, or both. The hopper system may be further augmented with a vibration-inducing motor, and/or the hopper system may further comprise channels through which coolant from the cooling system may pass.

More specifically, various implementations disclosed herein are directed to an automated battery breaking system comprising: a breaker comprising a top opening for receiving feedstock into the breaker and a bottom opening for output of broken feedstock from the breaker; a hopper operationally coupled to the breaker via the top opening, the hopper comprising a first opening for introduction of feedstock into the hopper and a second opening for controlled release of the feedstock from the hopper into the breaker; an adjustable gate valve capable of increasing or decreasing the flow of feedstock from the hopper into the breaker; and an automated gate valve controller for autonomously monitoring operating conditions of the breaker via a plurality of sensors and for automatically controlling the release of feedstock from the hopper into the breaker via the adjustable gate valve in response to the autonomously monitored operating conditions. Several such implementations may also comprise one or more of the following features: wherein the hopper further comprises a vibration-inducing motor fixedly coupled to the hopper for inducing vibration into the feedstock introduced into the hopper; wherein the hopper further comprises a set of damper springs for facilitating the vibration of the hopper and the feedstock introduced into the hopper; wherein the automated gate control valve controls the release of feedstock from the hopper into the breaker responsive to a sensed change in operating temperature of the breaker; wherein the automated gate control valve controls the release of feedstock from the hopper into the breaker responsive to a sensed change in resistance in the breaker; and/or wherein the flow of feedstock from the hopper to the breaker is gravity fed. Certain such implementations may also further comprise a cooling system for reducing the temperature of the feedstock, the breaker, or both.

Furthermore, various implementations disclosed herein are also directed to an automated battery breaking system comprising: a breaker comprising a top opening for receiving feedstock into the breaker and a bottom opening for output of broken feedstock from the breaker; a feeder jacket operationally coupled to the breaker via the top opening and through which feedstock is passed to the breaker, the feeder jacket comprising walls for physically containing the feedstock, said walls comprising channels through which coolant may be circulated to draw heat away from the feedstock physically contained by the jacket; a cooling system coupled to the feeder jacket for circulating coolant through the channels; and an automated cooling controller operationally coupled to the cooling system for autonomously monitoring temperature conditions of the breaker, the jacket, the feedstock, or any combination thereof via at least one sensor, and for automatically changing said temperature conditions by automatically changing the flow of coolant by the cooling system responsive to the autonomously monitored temperature conditions. Several such implementations may also comprise one or more of the following features: wherein the cooling system further comprises a pumping unit for circulating the coolant through the channels; wherein the cooling system further comprises a cooling assembly for receiving coolant that has been circulated through the channels, reducing the temperature of said coolant, and recirculating the coolant through the channels; and/or wherein the cooling system further comprises a cooling tower or a compressor/expander heat exchanger, and wherein the coolant is water or a refrigerant. Certain such implementations may also further comprise: a hopper operationally coupled to the breaker via the jacket, and/or a vibration-inducing motor fixedly coupled to the hopper for inducing vibration into the feedstock introduced into the hopper.

Additionally, various implementations disclosed herein are also directed to an automated battery breaking system comprising: a breaker comprising a top opening for receiving feedstock into the breaker and a bottom opening for output of broken feedstock from the breaker; a hopper operationally coupled to the breaker via the top opening, the hopper comprising a first opening for introduction of feedstock into the hopper and a second opening for controlled release of the feedstock from the hopper into the breaker, the hopper further comprising walls for physically containing the feedstock, said walls comprising channels through which coolant may be circulated to draw heat away from the feedstock physically contained by the hopper; a cooling system coupled to the hopper for circulating coolant through the channels; and an automated cooling controller operationally coupled to the cooling system for autonomously monitoring temperature conditions of the breaker, the hopper, the feedstock, or any combination thereof via at least one sensor, and for automatically changing said temperature conditions by automatically changing the flow of coolant by the cooling system responsive to the autonomously monitored temperature conditions. Several such implementations may also further comprise: an adjustable gate valve capable of increasing or decreasing the flow of feedstock from the hopper into the breaker; an automated gate valve controller for autonomously monitoring operating conditions of the breaker via a plurality of sensors and for automatically controlling the release of feedstock from the hopper into the breaker via the adjustable gate valve in response to the autonomously monitored operating conditions; and/or a jacket operationally coupled between the hopper and the breaker through which the feedstock passes, said jacket further comprising channels through which the coolant may also be circulated to draw heat away from the feedstock as it passes through said jacket. Certain implementations may also comprise one or more of the following features: wherein the automated gate valve controller and the automated cooling controller operate as a combined auto-controller for automatically controlling the release of feedstock from the hopper, for automatically changing the flow of coolant by the cooling system, or for a combination of both; wherein the hopper further comprises a vibration-inducing motor fixedly coupled to the hopper for inducing vibration into the feedstock introduced into the hopper; wherein the breaker further comprises channels through which the coolant may also be circulated to draw heat away from the feedstock as it is processed through said breaker; and/or wherein the hopper further comprises at least one cooling crossbar.

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1A is an illustration providing a partial cut-away side view of an automated battery breaking system (ABBS) comprising a hopper representative of various implementations disclosed herein;

FIG. 1B is an illustration providing a partial cut-away side view of the ABBS of FIG. 1A but shown in an alternative configuration representative of various implementations disclosed herein (with FIG. 1A and FIG. 1B collectively referred to herein as FIG. 1);

FIG. 2 is a process flow diagram illustrating an exemplary approach for automated operation of the ABBS of FIG. 1 in a manner representative of the various implementations disclosed herein;

FIG. 3 is an illustration providing a partial cut-away side view of a cooling system for utilization with the battery breaker of FIG. 1 when processing LIB feedstock, said cooling system being representative of various implementations disclosed herein;

FIG. 4 is a process flow diagram illustrating an exemplary approach for automated operation of the ABBS of FIG. 3 in a manner representative of the various implementations disclosed herein;

FIG. 5 is an illustration providing a cut-away side view of a cooling system for utilization with the ABBS of FIG. 1 (specifically FIG. 1A but equally applicable to FIG. 1B) when processing LIB feedstock, said cooling system being representative of various implementations disclosed herein;

FIG. 6 is a process flow diagram illustrating an exemplary approach for automated operation of the cooling system for the ABSS of FIG. 5 in a manner representative of the various implementations disclosed herein; and

FIG. 7 is a block diagram of an example computing environment that may be used in conjunction with any of the various implementations and aspects herein disclosed.

### DETAILED DESCRIPTION

An understanding of various concepts is helpful toward a broader and more complete understanding of the various implementations disclosed herein, and skilled artisans will readily appreciate the implications these various concepts have on the breadth and depth of the various implementations herein disclosed. And while the several and various implementations disclosed herein may be described as specifically pertaining to or directed to use in recycling of lithium-ion batteries (LIBs), such implementations may be equally applied to the recovery of other metals and/or other metal sources. Accordingly, nothing herein is intended to limit the various implementations solely to LIB recycling but, instead, the various implementations disclosed herein may be applied to a variety of different electrolytic processes and electrolysis-based operations, and thus the disclosures made herein should be read as broadly as possible as applied to a variety of different metals and other substances being extracted or recovered from a variety of potentially different sources. Furthermore, certain terms used herein may also be used interchangeably with other terms used herein and such terms should be given the broadest interpretation possible unless explicitly noted otherwise.

### Battery Breaking

As briefly described earlier herein, reclaiming the various components from spent lithium-ion batteries (LIBs) begins with “breaking” the batteries and grinding down to a fine powder for recovery of component materials. Although various spent LIBs may be segregated into different batches for breaking, such segregation is time and resource intensive and therefore uncommon. Instead, spent LIBs of various sizes and compositions are typically mixed together and separated into batches based only the most general distinctions (which may be referred to herein as “macro-batching”).

For example, relatively large batteries (such as those recovered from electric vehicles) might be easily segregated and separately processed from relatively small batteries (such as those recovered from consumer electronics) without much concern for whether any relatively medium-sized batteries end up in one macro-batch or the other. As such, the defining boundaries of macro-batches may substantially overlap but still achieve some easily-obtained efficiency warranting the time and effort expended for undertaking the macro-batching. Regardless, the resulting macro-batches will still typically comprise LIBs of varying sizes, shapes, and chemical compositions when fed into the breaker.

Even when macro-batching, it is current industry-wide practice to feed such batches into the breaker manually. This is because LIB feedstock may comprise—and often does comprise in substantial quantity—LIBs that are only partially discharged, mostly charged, or even fully charged. When these cells are broken in the battery breaker, the metallic lithium may become exposed to atmospheric moisture and result in chemical reactions that generate heat. In certain conditions, this heat may be sufficient enough to ignite the plastic components of the broken LIBs and generate even more heat and possibly open flames.

This unwanted heat may raise the temperature of the shredder and ancillary equipment and components in the immediate area to 120 degrees C. (248 degrees F.) and higher. At these temperatures, heat-sensitive components such as motors, electrical wiring, and rubber coatings may be damaged, and even more significant issues may arise as the temperature continues to increase and/or flames from burning plastics burn unchecked. Accordingly, manual breaker feeding is widely used to prevent such overheating conditions.

However, manual breaker feeding is slow, inefficient, and resource-intensive. To address this shortcoming and overcome the challenges that heretofore have necessitated manual feeding for LIB breaking, various implementations disclosed herein are directed to automatically feeding macro-batches of LIBs as feedstock into the breaker at controlled intervals and/or with a controlled flow rate to achieve more efficient and less-problematic breaking. This automatic feeding is achieved through the utilization of a specially-designed feeding system comprising one or more of the specific features described in the sections that follow.

### Feeding Via Hopper

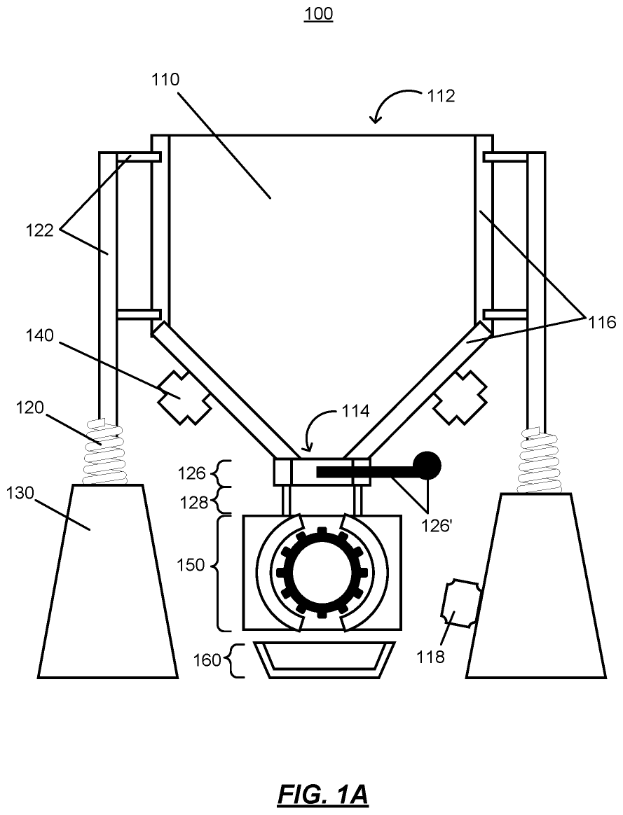

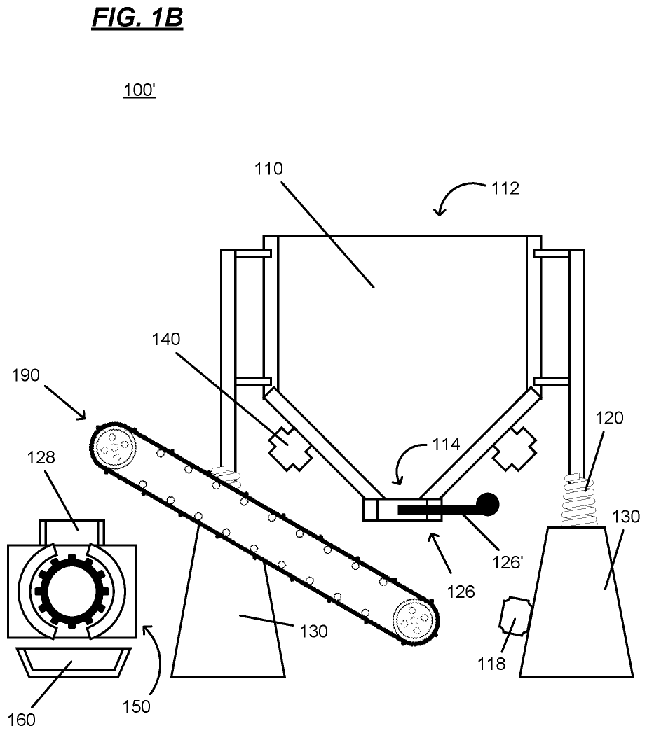

FIG. 1A is an illustration providing a partial cut-away side view of an automated battery breaking system (ABBS) 100 comprising a hopper 110 representative of various implementations disclosed herein. FIG. 1B is an illustration providing a partial cut-away side view of the ABBS of FIG. 1A but shown in an alternative configuration 100′ representative of various implementations disclosed herein (with FIG. 1A and FIG. 1B collectively referred to herein as FIG. 1). As known and appreciated by skilled artisans, a hopper (such as hopper 110) is a funnel-type container for bulk materials that typically receives contents at the top, tapers downward to form a functional funnel, and (via gravity) discharges its contents at the bottom of said funnel.

In FIG. 1, the ABBS 100 may comprise a hopper 110 having a first opening 112 for introduction of LIB feedstock (not shown) into the hopper 110 and a second opening 114 for controlled release of the LIB feedstock from the hopper 110 directly (as shown in FIG. 1A) or indirectly (such as via the belt-type conveyance system 190 as shown in FIG. 1B, for example) into a breaker 150. The hopper 110 may further comprise tapering walls 116 for physically containing and engaging the LIB feedstock emplaced in said hopper 110. The hopper 110 may also comprise a support structure 122.

As further shown in FIG. 1, the hopper 110 may be mounted, directly or via the support structure 122 (as shown), on a set of damper springs 120 (or other shock/vibration dissipators or suspension devices) that are fixedly coupled to a mounting base 130. At least one vibration-inducing motor (VIM) 140 may also be fixedly attached to the hopper 110 to induce vibration into the LIB feedstock introduced into the hopper 110 in order to facilitate gravity-driven movement of such LIB feedstock within the hopper 110 in a downward direction away from the first opening 112 and toward to the second opening 114. The set of damper springs 120 facilitate the vibration of the hopper 110 and the LIB feedstock contained therein while also limiting transfer of the vibration to the mounting base 130. An adjustable gate valve (AGV) 126—which may comprise a moveable gate structure 126′—may be operationally-coupled to the second opening 114 at the base of the hopper 110 to control the flow of LIB feedstock from the hopper 110 directly or indirectly into the breaker 150, through an intervening jacket 128 (to facilitate receipt of the feedstock by the breaker 150), and thereby also control the flow of the broken LIBs from the breaker 150 to a collecting vessel or surface 160 (which, for certain implementations, may be another belt-type conveyance system, for example).

An automated gate valve controller (GVC) 118 may also be operationally coupled to the ABBS 100 to monitor operating conditions (via a plurality of sensors, not shown) and increase or decrease the flow of LIB feedstock into the breaker 150 via the AGV 126—specifically, by opening the AGV 126 wider to control the release of LIB feedstock, that is, to increase the flow of LIB feedstock into the breaker 150, or by closing the AGV 126 narrower (more narrowly) to decrease the flow of LIB feedstock into the breaker 150. In this manner, the GVC 118 may operate to increase or decrease the flow of LIB feedstock based on any of several conditions that the GVC 118 may monitor (via the aforementioned plurality of sensors, not shown), including but not limited to temperature of any component of the ABBS 100, degree of resistance at the breaker 150, throughput of the breaker 150, weight of the LIB feedstock in the hopper 110 (or other measure equating to downward pressure being made by the LIB feedstock at the second opening 114 and the AGV 126), or any of other several operating conditions that are well-known and readily-appreciated by skilled artisans. The GVC 118 may also control the operating speed of the breaker 150 or other operating parameters of the ABBS 100.

The GVC 118 may comprise a combination of actuators, sensors, and computer hardware and/or software which may in turn further comprise a computer-readable medium comprising computer-executable instructions for guiding and controlling GVC 118 operations based on user inputs, thresholds, and other operating parameters.

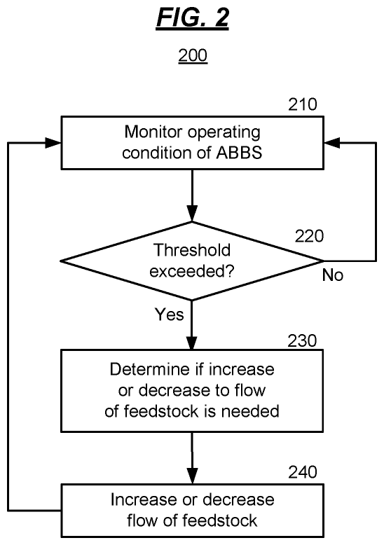

FIG. 2 is a process flow diagram 200 illustrating an exemplary approach for automated operation of the ABBS 100 of FIG. 1 in a manner representative of the various implementations disclosed herein. As shown in FIG. 2, at 210 the GVC 118 iteratively monitors at least one operating condition of the ABBS 100 to detect if any monitored operating condition exceeds a corresponding threshold (a “threshold condition”). Based on this monitoring, at 220 the GVC 118 may sense that at least one operating condition of the ABBS 100 is beyond a first threshold and, in response, at 230 the GVC 118 may then determine whether to increase or decrease the flow of LIB feedstock into the breaker 150. Based on this determination, at 240 the GVC 118 may then causes the AGV 126 (via operation of an actuator, for example) to increase or decrease the flow of LIB feedstock in the breaker 150 and then return to 110 to continue iteratively monitoring the ABBS 100.

Accordingly, various implementations disclosed herein are directed to an automated battery breaking system comprising: a breaker comprising a top opening for receiving feedstock into the breaker and a bottom opening for output of broken feedstock from the breaker; a hopper operationally coupled to the breaker via the top opening, the hopper comprising a first opening for introduction of feedstock into the hopper and a second opening for controlled release of the feedstock from the hopper into the breaker; an adjustable gate valve capable of increasing or decreasing the flow of feedstock from the hopper into the breaker; and an automated gate valve controller for autonomously monitoring operating conditions of the breaker via a plurality of sensors and for automatically controlling the release of feedstock from the hopper into the breaker via the adjustable gate valve in response to the autonomously monitored operating conditions. Several such implementations may also comprise one or more of the following features: wherein the hopper further comprises a vibration-inducing motor fixedly coupled to the hopper for inducing vibration into the feedstock introduced into the hopper; wherein the hopper further comprises a set of damper springs for facilitating the vibration of the hopper and the feedstock introduced into the hopper; wherein the automated gate control valve controls the release of feedstock from the hopper into the breaker responsive to a sensed change in operating temperature of the breaker; wherein the automated gate control valve controls the release of feedstock from the hopper into the breaker responsive to a sensed change in resistance in the breaker; and/or wherein the flow of feedstock from the hopper to the breaker is gravity fed. Certain such implementations may also further comprise a cooling system for reducing the temperature of the feedstock, the breaker, or both.

### Cooling System

As previously discussed herein, when LIBs are broken in the battery breaker, the metallic lithium may become exposed to atmospheric moisture and result in chemical reactions that generate heat and possibly open flames that may damage motors, electrical wiring, and rubber coatings, and cause even more significant issues.

Notably, the heat generated by these chemical reactions will mostly accumulate above the breaker itself and, when the LIB feedstock is fed into the breaker from above via the hopper configuration shown in FIG. 1A, this heat will be effectively trapped by and permeate into the LIB feedstock where it may further intensify among the unbroken LIBs. As such, by controlling the temperature of the LIB feedstock, the heat generated from the chemical reactions occurring during breaking could be substantially mitigated. On the other hand, this problem may be mitigated by configuration that locate the hopper 110 away from the top opening of the breaker 150 as shown in FIG. 1B.

In order to overcome the problem of systemic overheating during the breaking process, further disclosed herein are various implementations directed to a LIB feedstock cooling system for removing heat from the LIB feedstock—whether in the hopper 110 per FIG. 1A or just that portion of the feedstock in the jacket 128 per FIG. 1B—and preventing an elevation in temperature beyond an acceptable threshold.

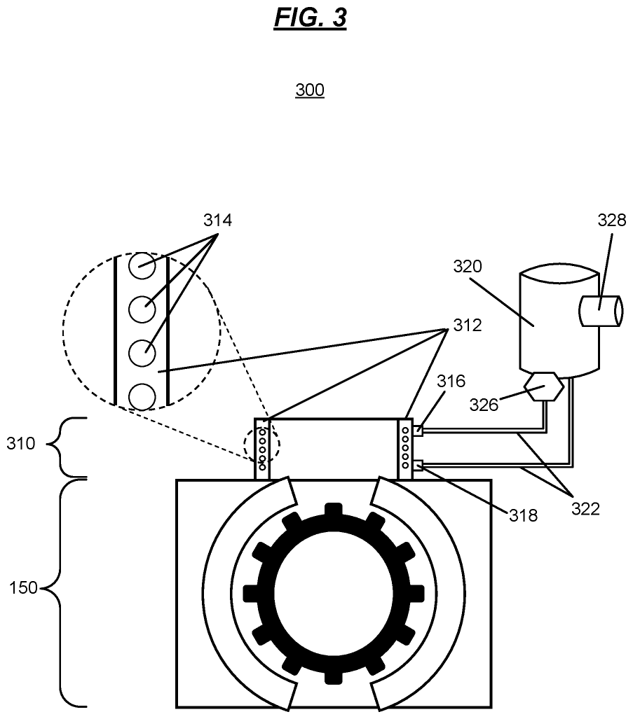

FIG. 3 is an illustration providing a partial cut-away side view of a cooling system 300 for utilization with the battery breaker 150 of FIG. 1 (also shown) when processing LIB feedstock, said cooling system 300 being representative of various implementations disclosed herein. In FIG. 3, the battery breaker 150 may be fitted with a feeder jacket 310 through which the LIB feedstock is fed directly into the breaker 150. The feeder jacket 310 may further comprise walls 312 for physically containing and engaging the LIB feedstock within its interior. These walls 312 may further comprise channels 314 through which coolant may be circulated in order to draw out heat generated at the breaker 150 that has permeated into the LIB feedstock.

For certain implementations, the cooling system 300 of FIG. 3 may be further augmented or extended in order to additionally provide cooling directly to the breaker 150, to any component for receiving the broken LIBs that exit the breaker 150 (not shown), or for any other component (or combination of components) of the ABBS 100 that may become overheated during operation (collectively the “additional cooling”). For select implementations, the additional cooling may be provided as an extension of the same cooling system 300 used for the feeder jacket 310 or may be a functionally separate and/or different cooling system than that used for the feeder jacket 310. For specific implementations, the additional cooling may be provided to some or all of the same components as the cooling system 300 including without limitation for additional cooling of the feeder jacket 310 itself. Furthermore, in some alternative implementations, the channel-based cooling system 300 of FIG. 3 may be utilized in one or more components of the ABBS 100 in lieu of utilization for cooling the feeder jacket 310.

In operation, the coolant—starting at a relatively low temperature with regard to the LIB feedstock—may enter the feeder jacket 310 at one or more entry points 316, circulate through the channels 314 in the walls 312 of the feeder jacket 310 to facilitate heat exchange into said coolant from the LIB feedstock engaged by the feeder jacket 310. The heated coolant, after reaching a relatively higher temperature due to the heat drawn away from the LIB feedstock, may then exit the feeder jacket 310 at one or more exit points 318 and pass to a cooling assembly 320 where the acquired heat is removed—via any of the several and diverse heat exchange processes known and appreciated by skilled artisans—to cool the coolant to a relatively lower temperature before returning the coolant to the feeder jacket 310 once again.

Coolant may travel between the feeder jacket 310 and the cooling assembly 320 via cooling pipes 322 that operationally connect the channels 314 of the feeder jacket 310 to the cooling assembly 320. Coolant may be circulated through the cooling system 300 by a pumping unit 326 which may be part of the cooling assembly 320 as shown or, in alternative implementations, may be a separate unit coupled to the cooling pipes 322 in a different location or operationally coupled, through the entry points 316 and exit points 318, to the channels 314 in the walls 312 of the feeder jacket 310.

The cooling system 300 may also further comprise an automated cooling controller (ACC) 328 operationally coupled to the cooling system and further comprising sensors for monitoring operating temperatures (via a plurality of temperature sensors, not shown) and increase or decrease the flow of coolant through the feeder jacket via control of the pumping unit 326 as well as controlling other components of the cooling assembly 320 (e.g., to decrease the temperature of the coolant), the speed of breaking being performed by the breaker 150, or any of other temperature-varying operating conditions known and appreciated by skilled artisans. In this manner, the ACC 328 may operate to increase or decrease the operating temperature of the ABBS 100.

As such, the ACC 328 may comprise a combination of temperature sensors, actuators, and other controls, as well as computer hardware and/or software which may in turn further comprise a computer-readable medium comprising computer-executable instructions for guiding and controlling cooling system 300 operations based on user inputs, thresholds, and other operating parameters.

For several such implementations, the coolant may be water, the channels may form a zig-zag pattern, or the cooling assembly 320 may comprise a cooling tower. For certain alternative implementations, the coolant may be a refrigerant (such as freon, R-22, or any other refrigerant) and/or the cooling assembly may comprise a compressor/expander heat exchanger. For select implementations, the heat drawn away by the cooling system 310 may be utilized in a separate process (e.g., one needing heat), used to generate electricity, utilized to at least partially power the breaker 150 itself, or used to power an input conveyance mechanism (not shown) directly or indirectly for introducing the LIB feedstock into the breaker 150 and/or used to power an output conveyance mechanism (not shown) used for directly or indirectly transporting the broken LIBs away from the breaker after the breaking is performed.

For certain implementations from among the several implementations where the coolant is water, certain implementations may operate to maintain the maximum coolant temperature at a threshold of approximately 60-80 degrees C. (approximately 140-176 degrees F.). To this end, select implementations may maintain a coolant flow rate of between approximately 150-170 liters per minute (approximately 40-45 gallons per minute).

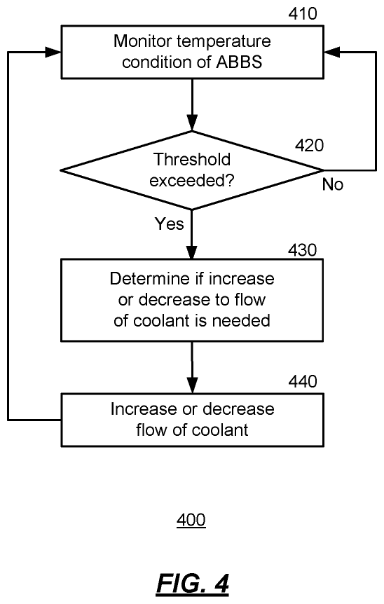

FIG. 4 is a process flow diagram 400 illustrating an exemplary approach for automated operation of the ABBS 100 of FIG. 3 in a manner representative of the various implementations disclosed herein. As shown in FIG. 4, at 410 the ACC 328 iteratively monitors at least one temperature condition of the ABBS 100 to detect if any monitored temperature exceeds a corresponding threshold (a “temperature condition”). Based on this monitoring, at 420 the ACC 328 may sense that at least one temperature condition of the ABBS 100 is beyond a first threshold and, in response, at 430 the ACC 328 may then determine whether to increase or decrease the flow of coolant into the feeder jacket 310. Based on this determination, at 440 the ACC 418 may then cause the pumping unit 326, for example, to increase or decrease the flow of coolant into the feeder jacket 310 and then return to 410 to continue iteratively monitoring the ABBS 100. Alternatively, the ACC may also or instead raise or lower the temperature of the coolant or take other measures that increase or decrease the cooling effect on the system.

Accordingly, various implementations disclosed herein are also directed to an automated battery breaking system comprising: a breaker comprising a top opening for receiving feedstock into the breaker and a bottom opening for output of broken feedstock from the breaker; a feeder jacket operationally coupled to the breaker via the top opening and through which feedstock is passed to the breaker, the feeder jacket comprising walls for physically containing the feedstock, said walls comprising channels through which coolant may be circulated to draw heat away from the feedstock physically contained by the jacket; a cooling system coupled to the feeder jacket for circulating coolant through the channels; and an automated cooling controller operationally coupled to the cooling system for autonomously monitoring temperature conditions of the breaker, the jacket, the feedstock, or any combination thereof via at least one sensor, and for automatically changing said temperature conditions by automatically changing the flow of coolant by the cooling system responsive to the autonomously monitored temperature conditions. Several such implementations may also comprise one or more of the following features: wherein the cooling system further comprises a pumping unit for circulating the coolant through the channels; wherein the cooling system further comprises a cooling assembly for receiving coolant that has been circulated through the channels, reducing the temperature of said coolant, and recirculating the coolant through the channels; and/or wherein the cooling system further comprises a cooling tower or a compressor/expander heat exchanger, and wherein the coolant is water or a refrigerant. Certain such implementations may also further comprise: a hopper operationally coupled to the breaker via the jacket, and/or a vibration-inducing motor fixedly coupled to the hopper for inducing vibration into the feedstock introduced into the hopper.

### Hopper Cooling System

For several implementations herein disclosed, the feeder jacket 310 may be part of, otherwise comprise, or be substituted with a hopper such as, for example, the vibrating hopper 110 described earlier herein with specific regard to FIG. 1A (but similarly applicable to FIG. 1B as well). For such implementations, the coolant may travel through hopper channels 314′ in the tapering walls 116 of the hopper 110 in the same fashion as described above for a feeder jacket 310.

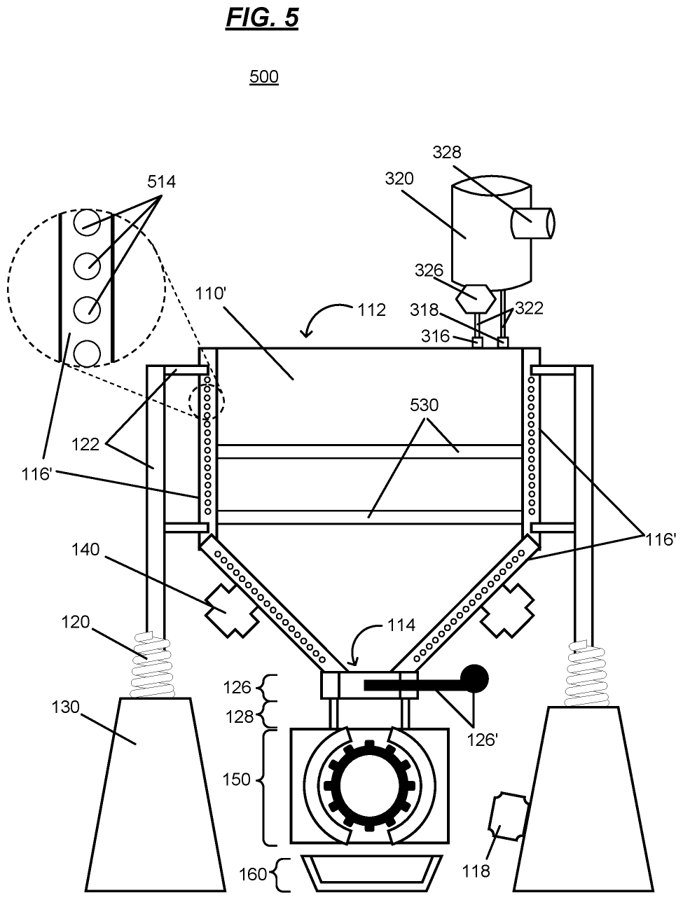

FIG. 5 is an illustration providing a cut-away side view of a cooling system 500 for utilization with the ABBS 100 of FIG. 1 (specifically FIG. 1A) when processing LIB feedstock, said cooling system 500 being representative of various implementations disclosed herein (and equally applicable to the system shown in FIG. 1B). In FIG. 5, the battery breaker 150 may comprise a hopper 110′ (in lieu of, and substituted for, the feeder jacket 310 of FIG. 3 for the configuration shown in FIG. 1A) from which LIB feedstock is fed directly into the breaker 150 (or indirectly as shown in FIG. 1B). The hopper 110′ may further comprise tapering walls 116′ for physically containing and engaging the LIB feedstock. These tapering walls 116′ may further comprise channels 514 through which coolant may be circulated in order to draw out heat generated at the breaker 150 that may have permeated into the LIB feedstock contained by the hopper 110′. Other features of the cooling system 500 may be similar or identical to any or all of the features described for the cooling system 300 earlier herein.

For certain implementations the hopper 110′ may also comprise one or more cooling crossbars 530 through which coolant may flow but yet around which the LIB feedstock continues its gravity-induced travel downward through the hopper 110′ substantially unimpeded. In any of various possible configurations, these cooling crossbars 530 may run horizontally at one or more levels (as shown)—in a parallel, perpendicular, or any other configuration—and/or may also run vertically or at various angles through the interior of said hopper 110′. When utilized, such cooling crossbars 530 may also provide additional structural support and/or integrity to the interior of the hopper 110′ to prevent bulging or other deformation of the hopper 110′ when filled with LIB feedstock.

Furthermore, for several such implementations, an automated gate valve controller (GVC) 118 may be combined with (or otherwise include) an automated cooling controller (ACC) 328 to form a combined auto-controller (CAC) (not shown) for performing the functions (and comprising various the components) of both the GVC 118 and the ACC 328, in whole or in part, as described in more detail earlier herein. For example, the CAC may make adjustments to the rate LIB feedstock is fed into the breaker 150, to the flow rate of the coolant through the hopper 110′, or both responsive to detected increases in temperature when exceeding a threshold.

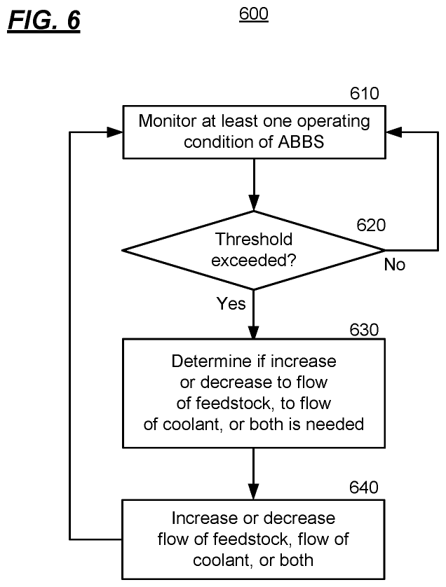

FIG. 6 is a process flow diagram 600 illustrating an exemplary approach for automated operation of the cooling system 500 for the ABSS 100 of FIG. 5 in a manner representative of the various implementations disclosed herein. As shown in FIG. 6, at 610 the CAC 518 may iteratively monitor at least one operating condition (e.g., temperature) of the ABBS 100 to detect if any monitored operating condition exceeds a corresponding threshold (a “threshold condition”) such as, for example, temperature. Based on this monitoring, at 620 the CAC 518 may sense that at least one operating condition of the ABBS 100 is beyond a first threshold and, in response, at 630 the CAC 518 may then determine whether to increase or decrease the flow of LIB feedstock into the breaker 150, or increase or decrease the flow rate of the coolant through the hopper 110′, or both, and/or take any other action or combination of actions deemed appropriate. Based on this determination, at 640 the CAC 518 may then causes the AGV 126 (via operation of an actuator, for example) to increase or decrease the flow of LIB feedstock in the breaker 150 and/or increase or decrease the flow rate of the coolant through the hopper 110′ (via operation of the pumping unit 326, for example) and then return to 110 to continue iteratively monitoring the ABBS 100.

Accordingly, various implementations disclosed herein are also directed to an automated battery breaking system comprising: a breaker comprising a top opening for receiving feedstock into the breaker and a bottom opening for output of broken feedstock from the breaker; a hopper operationally coupled to the breaker via the top opening, the hopper comprising a first opening for introduction of feedstock into the hopper and a second opening for controlled release of the feedstock from the hopper into the breaker, the hopper further comprising walls for physically containing the feedstock, said walls comprising channels through which coolant may be circulated to draw heat away from the feedstock physically contained by the hopper; a cooling system coupled to the hopper for circulating coolant through the channels; and an automated cooling controller operationally coupled to the cooling system for autonomously monitoring temperature conditions of the breaker, the hopper, the feedstock, or any combination thereof via at least one sensor, and for automatically changing said temperature conditions by automatically changing the flow of coolant by the cooling system responsive to the autonomously monitored temperature conditions. Several such implementations may also further comprise: an adjustable gate valve capable of increasing or decreasing the flow of feedstock from the hopper into the breaker; an automated gate valve controller for autonomously monitoring operating conditions of the breaker via a plurality of sensors and for automatically controlling the release of feedstock from the hopper into the breaker via the adjustable gate valve in response to the autonomously monitored operating conditions; and/or a jacket operationally coupled between the hopper and the breaker through which the feedstock passes, said jacket further comprising channels through which the coolant may also be circulated to draw heat away from the feedstock as it passes through said jacket. Certain implementations may also comprise one or more of the following features: wherein the automated gate valve controller and the automated cooling controller operate as a combined auto-controller for automatically controlling the release of feedstock from the hopper, for automatically changing the flow of coolant by the cooling system, or for a combination of both; wherein the hopper further comprises a vibration-inducing motor fixedly coupled to the hopper for inducing vibration into the feedstock introduced into the hopper; wherein the breaker further comprises channels through which the coolant may also be circulated to draw heat away from the feedstock as it is processed through said breaker; and/or wherein the hopper further comprises at least one cooling crossbar.

### Example Computing Environment

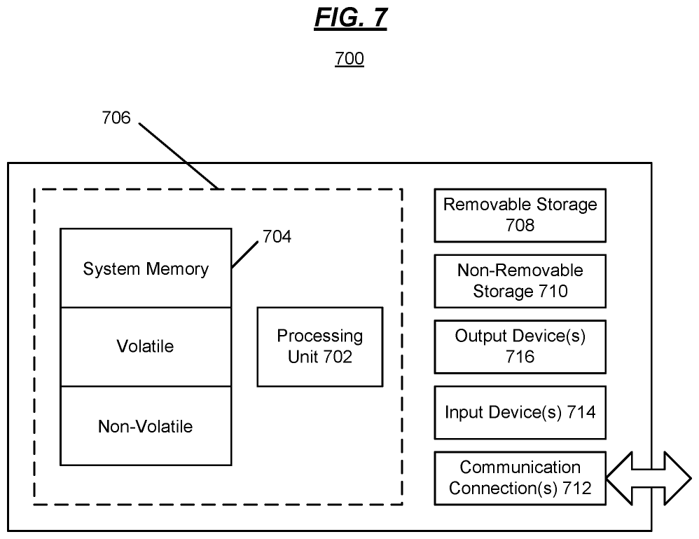

FIG. 7 is a block diagram of an example computing environment that may be used in conjunction with example implementations and aspects such as those disclosed and described with regard to the other figures presented herein and herewith. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA), an analog-to-digital converter (ADC), or other programmable logic device, discrete gate or transistor logic, discrete hardware components, discrete data acquisition components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

With reference to FIG. 7, an example system for implementing aspects described herein includes a computing device, such as computing device 700. In a basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This basic configuration is illustrated in FIG. 7 by dashed line 706 and may be referred to collectively as the “compute” component.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710. Computing device 700 typically includes a variety of computer readable media. Computer readable media can be any available media that can be accessed by device 700 and may include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store the information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, and so forth. Output device(s) 716 such as a display, speakers, printer, and so forth may also be included. All these devices are well-known in the art and need not be discussed at length herein. Computing device 700 may be one of a plurality of computing devices 700 inter-connected by a network. As may be appreciated, the network may be any appropriate network, each computing device 700 may be connected thereto by way of communication connection(s) 712 in any appropriate manner, and each computing device 700 may communicate with one or more of the other computing devices 700 in the network in any appropriate manner. For example, the network may be a wired or wireless network within an organization or home or the like, and may include a direct or indirect coupling to an external network such as the Internet or the like. Moreover, PCI, PCIe, and other bus protocols might be utilized for embedding the various implementations described herein into other computing systems.

### Interpretation of Disclosures Herein

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high-level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. In one example, the controller service may be accessed by a mobile device. In another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

### Anticipated Alternatives

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims. For particular implementations described with reference to block diagrams and/or operational illustrations of methods, it should be understood that each block of the block diagrams and/or operational illustrations, and combinations of blocks in the block diagrams and/or operational illustrations, may be implemented by analog and/or digital hardware, and/or computer program instructions. Computer program instructions for use with or by the implementations disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system. The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device. Volatile media may include dynamic memory, such as main memory. Transmission media may include coaxial cables, copper wire, and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

In the foregoing description, for purposes of explanation and non-limitation, specific details are set forth—such as particular nodes, functional entities, techniques, protocols, standards, etc.—in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims presented below.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. An automated battery breaking system comprising:
a breaker comprising a top opening for receiving feedstock into the breaker and a bottom opening for output of broken feedstock from the breaker;
a hopper operationally coupled to the breaker via the top opening, the hopper comprising a first opening for introduction of feedstock into the hopper and a second opening for controlled release of the feedstock from the hopper into the breaker;
an adjustable gate valve capable of increasing or decreasing the flow of feedstock from the hopper into the breaker; and
an automated gate valve controller for autonomously monitoring operating conditions of the breaker via a plurality of sensors and for automatically controlling the release of feedstock from the hopper into the breaker via the adjustable gate valve in response to the autonomously monitored operating conditions.

2. The system of claim 1, wherein the hopper further comprises a vibration-inducing motor fixedly coupled to the hopper for inducing vibration into the feedstock introduced into the hopper.

3. The system of claim 2, wherein the hopper further comprises a set of damper springs for facilitating the vibration of the hopper and the feedstock introduced into the hopper.

4. The system of claim 1, wherein the automated gate control valve controls the release of feedstock from the hopper into the breaker responsive to a sensed change in operating temperature of the breaker.

5. The system of claim 1, wherein the automated gate control valve controls the release of feedstock from the hopper into the breaker responsive to a sensed change in resistance in the breaker.

6. The system of claim 1, wherein the flow of feedstock from the hopper to the breaker is gravity fed.

7. The system of claim 1, further comprising a cooling system for reducing the temperature of the feedstock, the breaker, or both.

8. An automated battery breaking system comprising:
a breaker comprising a top opening for receiving feedstock into the breaker and a bottom opening for output of broken feedstock from the breaker;
a feeder jacket operationally coupled to the breaker via the top opening and through which feedstock is passed to the breaker, the feeder jacket comprising walls for physically containing the feedstock, said walls comprising channels through which coolant may be circulated to draw heat away from the feedstock physically contained by the jacket;
a cooling system coupled to the feeder jacket for circulating coolant through the channels; and
an automated cooling controller operationally coupled to the cooling system for autonomously monitoring temperature conditions of the breaker, the jacket, the feedstock, or any combination thereof via at least one sensor, and for automatically changing said temperature conditions by automatically changing the flow of coolant by the cooling system responsive to the autonomously monitored temperature conditions.

9. The system of claim 8, wherein the cooling system further comprises a pumping unit for circulating the coolant through the channels.

10. The system of claim 8, wherein the cooling system further comprises a cooling assembly for receiving coolant that has been circulated through the channels, reducing the temperature of said coolant, and recirculating the coolant through the channels.

11. The system of claim 8, further comprising a hopper operationally coupled to the breaker via the jacket.

12. The system of claim 11, further comprising a vibration-inducing motor fixedly coupled to the hopper for inducing vibration into the feedstock introduced into the hopper.

13. The system of claim 8, wherein the cooling system further comprises a cooling tower or a compressor/expander heat exchanger, and wherein the coolant is water or a refrigerant.

14. An automated battery breaking system comprising:
a breaker comprising a top opening for receiving feedstock into the breaker and a bottom opening for output of broken feedstock from the breaker;
a hopper operationally coupled to the breaker via the top opening, the hopper comprising a first opening for introduction of feedstock into the hopper and a second opening for controlled release of the feedstock from the hopper into the breaker, the hopper further comprising walls for physically containing the feedstock, said walls comprising channels through which coolant may be circulated to draw heat away from the feedstock physically contained by the hopper;
a cooling system coupled to the hopper for circulating coolant through the channels; and
an automated cooling controller operationally coupled to the cooling system for autonomously monitoring temperature conditions of the breaker, the hopper, the feedstock, or any combination thereof via at least one sensor, and for automatically changing said temperature conditions by automatically changing the flow of coolant by the cooling system responsive to the autonomously monitored temperature conditions.

15. The system of claim 14, further comprising:
an adjustable gate valve capable of increasing or decreasing the flow of feedstock from the hopper into the breaker; and
an automated gate valve controller for autonomously monitoring operating conditions of the breaker via a plurality of sensors and for automatically controlling the release of feedstock from the hopper into the breaker via the adjustable gate valve in response to the autonomously monitored operating conditions.

16. The system of claim 15, wherein the automated gate valve controller and the automated cooling controller operate as a combined auto-controller for automatically controlling the release of feedstock from the hopper, for automatically changing the flow of coolant by the cooling system, or for a combination of both.

17. The system of claim 14, wherein the hopper further comprises a vibration-inducing motor fixedly coupled to the hopper for inducing vibration into the feedstock introduced into the hopper.

18. The system of claim 14, further comprising a jacket operationally coupled between the hopper and the breaker through which the feedstock passes, said jacket further comprising channels through which the coolant may also be circulated to draw heat away from the feedstock as it passes through said jacket.

19. The system of claim 14, wherein the breaker further comprises channels through which the coolant may also be circulated to draw heat away from the feedstock as it is processed through said breaker.

20. The system of claim 14, wherein the hopper further comprises at least one cooling crossbar.
